(19) United States
(12) Patent Application Publication
(10) Pub. No.: US 2022/0301017 A1
(43) Pub. Date: Sep. 22, 2022

(54) SERVER AND CONTROLLING METHOD THEREOF

(71) Applicant: SAMSUNG ELECTRONICS CO., LTD., Suwon-si (KR)

(72) Inventors: Minjung KIM, Suwon-si (KR); Kwangwon KO, Suwon-si (KR); Heejin KIM, Suwon-si (KR); Jongchul PARK, Suwon-si (KR)

(73) Assignee: SAMSUNG ELECTRONICS CO., LTD., Suwon-si (KR)

(21) Appl. No.: 17/836,424

(22) Filed: Jun. 9, 2022

Related U.S. Application Data
(63) Continuation of application No. PCT/KR2021/012607, filed on Sep. 15, 2021.

(30) Foreign Application Priority Data
Nov. 20, 2020 (KR) 10-2020-0156861
Feb. 10, 2021 (KR) 10-2021-0019283

(51) Int. Cl. G06Q 30/02; G06N 3/04; G06N 7/00

(52) U.S. Cl. CPC G06Q 30/0275; G06N 3/0454; G06N 7/005

(57) ABSTRACT

A server includes a communicator, a memory configured to store a first neural network model trained to predict winning probability distribution for a bidding price based on advertisement history data of an advertiser and a second neural network model, and a processor configured to, based on receiving a bidding request from an external server, obtain response probability data of a user based on user information included in the bidding request, obtain a first winning probability distribution by inputting data with respect to an auction of an advertiser and the response probability data of the user to the first neural network model and obtain a second winning probability distribution by inputting noise data to the second neural network model, and identify a bidding price based on the first and second winning probability distributions and control the communicator to transmit the identified bidding price to the external server.

### CROSS-REFERENCE TO RELATED APPLICATION(S)

This application is a bypass continuation of International Application No. PCT/KR2021/012607, filed on Sep. 15, 2021, which is based on and claims priority to Korean Patent Application No. 10-2020-0156861, filed on Nov. 20, 2020 and Korean Patent Application No. 10-2021-0019283, filed on Feb. 10, 2021, in the Korean Intellectual Property Office, the disclosure of which are incorporated by reference herein in their entireties.

### BACKGROUND

### 1. Field

The disclosure relates to a server and a controlling method thereof and, more particularly, to a server for proposing an optimal bidding price in real time bidding (RTB) and a controlling method thereof.

### 2. Description of the Related Art

A scale of a digital advertising market is being increased. Digital advising means impression of advertising content of an advertiser through a publisher for the purpose of attracting an attention of a user or a customer (hereinafter, referred to as a user) accessed to an on-line publisher.

Recently, an auction in the digital advertising is mainly done by a real time bidding (RTB) method. In the RTB, when a user accesses a publisher, an auction is performed, and a transaction of an advertisement area between the publisher and a winning advertiser is performed, and the advertisement content of the advertiser is exposed to the user at a time (e.g., 200 ms, etc.) close to real time.

In a real time bidding method, an automated advertising system including a demand side platform (DSP) is required. Here, the DSP is an automated server (or system) to immediately respond to a bidding request on behalf of an advertiser, and if there is a bidding request indicating that an auction begins, a bidding price may be determined based on a user, a time, an advertisement area, a price, etc. desired for the advertisement within a very short time, which is close to real time, and bidding for the auction may be performed with a determined bidding price. As such, the DSP serves to help the advertiser to automatically perform transactions between the publisher and the advertiser.

In order to maximize advertising efficiency, there is a problem of price optimization associated with determining how much bidding price the DSP will determine. In particular, in a method for predicting a current bidding price based on statistical data for an auction performed in the past, if there is a new environment (e.g., introduction of a new user, or the like) on an advertisement platform that is different from the previous environment, there is a problem that a bidding price suitable for the new environment may not be predictable. In addition, there is a problem that an advertiser may not interfere in determination of a bidding price in an automated advertising system.

### SUMMARY

The disclosure provides a server for proposing an optimal bidding price in a real time bidding and a controlling method thereof.

According to an aspect of an example embodiment, there is provided a server including: a communication interface; a memory configured to store a first neural network model and a second neural network model, the first neural network model being trained to predict a first winning probability distribution for a bidding price based on advertisement history data of an advertiser and the second neural network model being trained to output a second winning probability distribution, an approximation degree between the first winning probability distribution output from the first neural network model and the second winning probability distribution exceeding a threshold value; and a processor configured to: based on receiving, through the communication interface, a bidding request for an advertisement area from an external server that manages posting, on a network, an advertisement for the advertisement area, obtain response probability data of a user based on user information included in the bidding request, the response probability data indicating a probability of the user, when exposed to the advertisement, responding to the advertisement posted in the advertisement area; obtain the first winning probability distribution by inputting, to the first neural network model, auction-related data of the advertiser and the response probability data of the user, and obtain the second winning probability distribution by inputting noise data to the second neural network model; and identify a bidding price based on the first and second winning probability distributions and control the communication interface to transmit the identified bidding price to the external server, upon which a winning advertiser whose advertisement is to be posted in the advertisement area is determined.

The second neural network model may be a generator model in which a probability value output from a discriminator model exceeds the threshold value, and wherein the discriminator model is trained to output a probability value for the approximation degree between the first winning probability distribution output from the first neural network model and the second winning probability distribution output from the second neural network model.

The processor may be further configured to identify a bidding price that has a highest winning probability among winning probabilities for respective bidding prices based on the first and second winning probability distributions obtained from the first and second neural network models, and control the communication interface to transmit the identified bidding price to the external server.

The processor may be further configured to: based on receiving information about a budget consumption ratio of the advertiser through the communication interface, store the information about the budget consumption ratio in the memory; and identify the bidding price based on the first and second winning probability distributions and the stored budget consumption ratio, and control the communication interface to transmit the identified bidding price to the external server.

The processor may be further configured to: based on receiving information about a maximum payment amount of the advertiser through the communication interface, store the information about the maximum payment amount per auction in the memory; and identify a bidding price having a highest winning probability within a range of the maximum payment amount among winning probabilities for respective bidding prices based on the first and second winning probability distributions obtained from the first and second neural network models, and control the communication interface to transmit the identified bidding price to the external server.

The advertisement history data may include, based on the advertiser posting a previous advertisement in a previous advertisement area according to a result of a past bidding, information about a click rate indicating a number of clicks of the previous advertisement with respect to a number of impression of the previous advertisement, a number of participations of the advertiser in an auction during a preset period, a number of winning by the advertiser, a winning price, and a budget of the advertiser during the preset period.

The user information included in the bidding request may include information about at least one of gender of the user, a date of birth of the user, a location of the user, a time of access of the user, a terminal device used by the user, whether the user is under general data protection regulation (GDPR), whether the user clicks the advertisement, a search keyword of the user, information on an on-line publisher providing the advertisement area, information on the advertisement area, or a preference of the user with respect to the advertisement area.

The auction-related data of the advertiser may include information about at least one of a number of remaining auctions during a bidding period of the advertiser and an amount of a remaining budget out of an entire budget of the advertiser.

According to an aspect of an example embodiment, there is provided a method of controlling a server, the method including: receiving a bidding request for an advertisement area from an external server that manages posting, on a network, an advertisement for the advertisement area; obtaining response probability data of a user with respect to the advertisement area based on user information included in the bidding request, the response probability data indicating a probability of the user responding to the advertisement posted in the advertisement area; obtaining a first winning probability distribution by inputting auction-related data of an advertiser and the response probability data of the user to a first neural network model and obtaining a second winning probability distribution by inputting noise data to a second neural network model; identifying a bidding price based on the first and second winning probability distributions, upon which a winning advertiser whose advertisement is to be posted in the advertisement area is determined; and transmitting the identified bidding price to the external server, wherein the first neural network model is trained to predict the first winning probability distribution for a bidding price based on advertisement history data of the advertiser, and wherein the second neural network model is trained to output the second winning probability distribution, an approximation degree between the first winning probability distribution output from the first neural network model and the second winning probability distribution exceeding a threshold value.

The second neural network model may be a generator model in which a probability value output from a discriminator model exceeds the threshold value, and wherein the discriminator model is trained to output a probability value for the approximation degree between the first winning probability distribution output from the first neural network model and the second winning probability distribution output from the second neural network model.

The identifying may include identifying a bidding price that has a highest winning probability among winning probabilities for respective bidding prices based on the first and second winning probability distributions obtained from the first and second neural network models.

The method may further include: based on receiving information about a budget consumption ratio of the advertiser, storing the information about the budget consumption ratio in a memory of the server, wherein the identifying comprises identifying the bidding price based on the first and second winning probability distributions and the stored budget consumption ratio.

The method may further include: based on receiving information about a maximum payment amount of the advertiser, storing the information about the maximum payment amount per auction in a memory of the server, wherein the identifying comprises identifying a bidding price having a highest winning probability within a range of the maximum payment amount among winning probabilities for respective bidding prices based on the first and second winning probability distributions obtained from the first and second neural network models.

The advertisement history data may include, based on the advertiser posting a previous advertisement in a previous advertisement area according to a result of a past bidding, information about a click rate indicating a number of clicks of the previous advertisement with respect to a number of impression of the previous advertisement, a number of participations of the advertiser in an auction during a preset period, a number of winning by the advertiser, a winning price, and a budget of the advertiser during the preset period.

The user information included in the bidding request may include information about at least one of gender of the user, a date of birth of the user, a location of the user, a time of access of the user, a terminal device used by the user, whether the user is under general data protection regulation (GDPR), whether the user clicks the advertisement, a search keyword of the user, information on an on-line publisher providing the advertisement area, information on the advertisement area, or a preference of the user with respect to the advertisement area.

According to various embodiments of the disclosure, a server for proposing an optimal bidding price in a real time bidding and a controlling method thereof are provided.

In addition, a server in which an advertiser may intervene in determining a bidding price in a process of real time bidding and a controlling method thereof are provided.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating a system according to an embodiment;

FIG. 2 is a block diagram illustrating a configuration of a server according to an embodiment;

FIG. 3 is a diagram illustrating a winning probability distribution according to an embodiment;

FIG. 4 is a diagram illustrating a method for determining a final bidding price according to an embodiment;

FIG. 5 is a diagram illustrating a method for obtaining response probability data of a user according to an embodiment;

FIG. 6 is a diagram illustrating a method of training a first neural network model according to an embodiment;

FIGS. 7A and 7C are diagrams illustrating a method of training a second neural network model according to an embodiment;

FIG. 8 is a diagram illustrating an embodiment in which intervention of an advertiser in a final bidding price is possible according to an embodiment;

FIG. 9 is a diagram illustrating a user interface (UI) provided to an advertiser according to an embodiment;

FIG. 10 is a block diagram illustrating an additional configuration of a server according to an embodiment; and

FIG. 11 is a flowchart illustrating a method for controlling a server according to an embodiment.

### DETAILED DESCRIPTION

Hereinafter, embodiments of the inventive concept will be described in detail with reference to the accompanying drawings.

In describing the disclosure, a detailed description of known functions or configurations incorporated herein will be omitted if it may make the subject matter of the disclosure unclear. In addition, the example embodiments described below may be modified in various different forms, and the scope of the technical concept of the disclosure is not limited to the following embodiments. Rather, these embodiments are provided so that this disclosure will be thorough and complete, and will fully convey the scope of the disclosure to those skilled in the art.

This disclosure is not intended to limit the embodiments described herein but includes various modifications, equivalents, and/or alternatives. In the context of the description of the drawings, like reference numerals may be used for similar components.

As used herein, terms such as “first,” and “second,” may identify corresponding components, regardless of order and/or importance, and are used to distinguish a component from another without limiting the components.

The expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

A singular expression includes a plural expression, unless otherwise specified. It is to be understood that the terms such as “comprise” may, for example, be used to designate a presence of a characteristic, number, step, operation, element, component, or a combination thereof, and not to preclude a presence or a possibility of adding one or more of other characteristics, numbers, steps, operations, elements, components or a combination thereof.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

The expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a central processing unit (CPU) or an application processor) that may perform the corresponding operations by executing one or more software programs stored in a memory device.

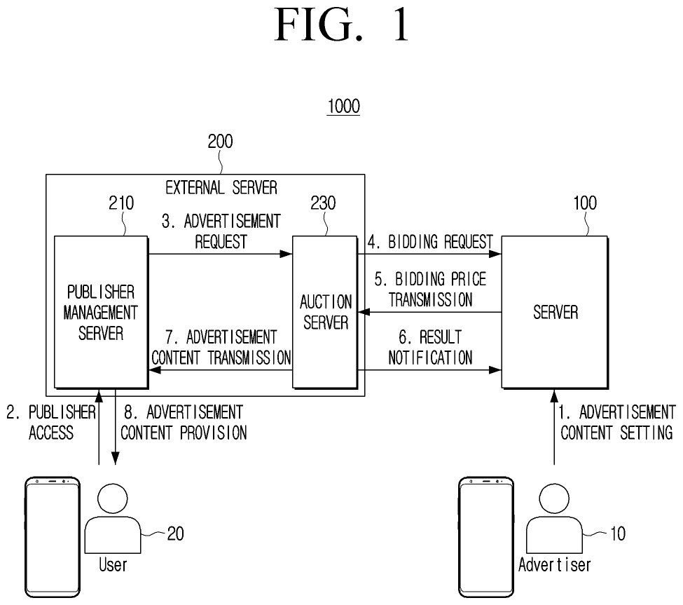

FIG. 1 is a diagram illustrating a system according to an embodiment.

Referring to FIG. 1, a system 1000 may expose the advertisement content of an advertiser 10 to a user 20 through a real time bidding scheme. The system 1000 may include a server 100 and an external server 200, and the server 100 and the external server 200 may be connected to each other through a network. The external server 200 may include a publisher management server 210 and an auction server 230 for managing advertisement posting for an advertisement area (or advertisement slot, page, or inventory, etc.) on the network. The publisher management server 210 and the auction server 230 may be operated by the same subject or different subjects.

The real time bidding method refers to a method of receiving a bidding price from advertisers participating in the bidding (i.e., performing bidding), selecting a winner among the advertisers based on the bidding price, and exposing the advertisement content of the winner to the user 20. The auction may proceed during a time close to real time (e.g., 100 ms, 200 ms, etc.).

First, the advertiser 10 may register (or pre-register) the auction-related data of the advertiser 10 to the server 100 to participate in the auction. The auction-related data may include advertisement content, bidding budget, bidding period, and the like. At this time, the server 100 may register and store auction-related data in units of advertisers, and in this case, the server 100 may participate in the auction in units of advertisers. Based on the registered auction-related data, when a bidding request is from the external server 200 (e.g., auction server 230), the server may immediately participate in a bidding for the advertisement area, on behalf of the advertiser, by performing a real time bidding method.

The advertiser 10 refers to a main subject for advertising activity, and for example, the advertiser 10 may be a person, an organization, a corporation, an enterprise, or the like that purchases an advertisement area of the publisher and posts advertisement content in an advertisement area of the publisher. The advertisement content is content made in a purpose to inform the user 20, who is a potential consumer, of information about a product or service, and may be made in at least one digital advertisement type selected from a video, an image, a character, or the like.

The user 20 may access the publisher via the terminal device. The user 20 may include a general consumer or potential consumer, who may be attracted to purchase the product or service through the advertisement content of the advertiser. The terminal device of the user 20 may include various electronic devices, such as a smartphone, a desktop computer, a laptop computer, a portable computer, a tablet computer, a wearable device, or the like.

When the terminal device of the user 20 approaches (or accesses) the publisher, the publisher management server 210 may transmit the advertisement request to the auction server 230 to sell the advertisement area of the publisher. The advertisement request may indicate a notification requesting to transmit the winning advertisement content as a result of participating in the auction.

The publisher may represent content (e.g., a web page, an Internet search service, a social network service (SNS), a messenger, a community, a video content, a game content, an application, an application market, etc.) which is manufactured or operated by a service provider such as a personal, a group, an enterprise, etc. The publisher may be various digital types of content accessible through various terminal devices of the user 20. Also, the publisher may provide an advertising area in which the advertisement content is posted.

The publisher management server 210 may identify a publisher accessed by the user 20. For example, if the publisher has an access by the user 20, an instruction for transmitting information to the publisher management server 210 may be set, and the publisher management server 210 may identify a publisher accessed by the user 20 based on the received information. If the publisher accessed by the user 20 is identified, the publisher management server 210 may transmit an advertisement request for the user 20 to the auction server 230.

The publisher management server 210 may be implemented as a single server device, or may be implemented as a system including a plurality of server devices. For example, the publisher management server 210 may be implemented with a system that includes a hosting device that provides a website and a data space for a publisher that allows the user 20 to access on a network, and a supply side platform (SSP) server device that manages the advertisement area of the publisher.

If an advertisement request is received, the auction server 230 may transmit a bidding request to the server 100. The auction server 230 may serve as an exchange for mediating transactions (sales and purchase) for the advertising area in a real time bidding manner. At this time, the server 100 to which the bidding request is transmitted may be implemented as one server or a plurality of servers connected to the auction server 230 through a network.

When the bidding request is received, the server 100 may transmit information about the advertiser 10 and the bidding price of the advertiser 10 to the auction server 230 to purchase the advertisement area of the publisher from the advertiser (i.e., the purchaser) 10. The server 100 may be a demand side platform (DSP) server device that participates in bidding on behalf of the advertiser 10. Information on the advertiser 10 may include account information of the advertiser 10 for making payment corresponding to the successful bidding price, when the advertiser 10 wins the bidding, or the payment amount to be made to an account of the service provider.

When the bidding request is received during the bidding period of the advertiser 10, the server 100 may determine a bidding price within the range of the bidding budget of the advertiser 10 and transmit the determined bidding price to the auction server 230. For example, the server 100 may transmit the bidding price of the advertiser 10 to the auction server 230 so that the advertiser 10 participates in the corresponding bidding, if the time when the bidding request of the advertiser 10 is received (e.g., May 3, 2020) falls within the bidding period (e.g., May 1 to May 5, 2020). The server 100 may not transmit the bidding price of the advertiser 10 to the auction server 230 so that the advertiser 10 does not participate in the corresponding bidding when the time at the bidding request is received does not belong to the bidding period (i.e., before or after the bidding period).

When the bidding price of the at least one advertiser is received from the server 100, the auction server 230 may select a winning advertiser (i.e., a winner) based on the bidding price of the at least one advertiser.

The auction server 230 may select a winner through a first price auction or a second price auction.

More specifically, the first price auction is a method in which an advertiser who suggests the highest bidding price among all bidding prices presented in the auction is selected as a winner, and the winner pays the highest bidding price (i.e., the bidding price proposed by the winning advertiser) as a successful bidding price. The second price auction is a method in which an advertiser who suggests the highest bidding price among all bidding prices presented in the auction is selected as a winner, and the winner pays a second highest bidding price (or an amount of adding a predetermined price to the second highest price) among the total bidding prices as a successful bidding price. The above-described method is merely an example, and a winner may be selected through various bidding methods.

When a winner is selected, the auction server 230 may transmit the real time bidding result to the server 100. For example, information on a winner and information on a successful bidding price may be transmitted to the server 100 as a result of real time bidding. Also, when a winner is selected, the auction server 230 may transmit information to a financial server in association with the auction server 230 to pay the bidding price to the service provider from the account of the winner.

The server 100 may transmit, to the auction server 230, advertisement content of a winner from at least one advertiser managed by the server 100 based on a received result of the real time bidding. In another embodiment, when the server 100 transmits the bidding price of the advertiser 10 to the auction server 230 in response to the bidding request received from the auction server 230, the server 100 may transmit the advertisement content of the advertiser 10 to the auction server 230 along with the bidding price of the advertiser 10.

The auction server 230 may transmit the advertisement content of the winner to the publisher management server 210. The publisher management server 210 may provide the user 20 with advertisement content by posting the advertisement content received from the winner determined through the real time bidding to the advertisement area of the publisher (e.g., a display). Accordingly, the user 20 may be exposed to advertisement content inserted into the advertisement area of the publisher.

As such, when the terminal device of the user 20 accesses a publisher, the advertisement content of the successful advertiser may be provided to the user 20 through the real time bidding.

According to an embodiment, when the server 100 determines a bidding price of the advertiser, the bidding price may be determined by using advertisement history data or noise data of the advertiser.

According to an embodiment, an optimal bidding price may be determined at a current situation of the advertiser while flexibly reflecting a dynamic market situation, which will be described later in greater detail.

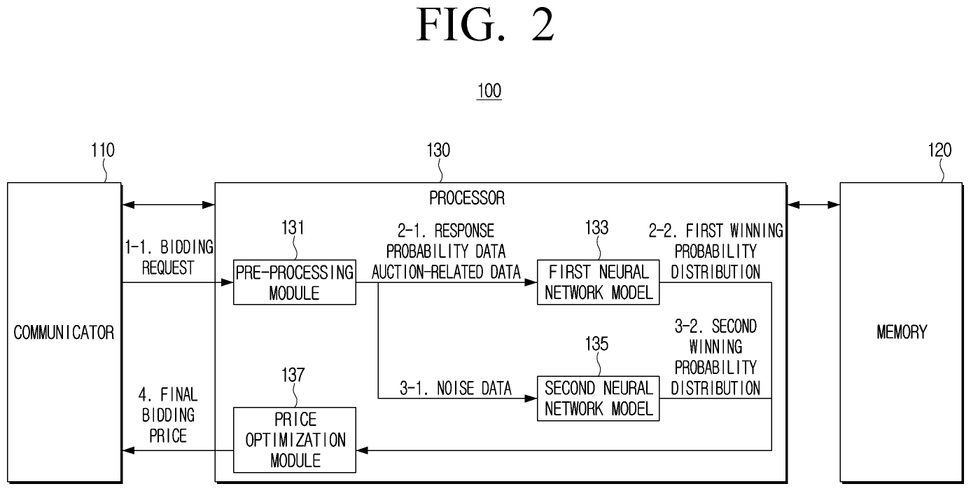

FIG. 2 is a block diagram illustrating a configuration of the server 100 according to an embodiment. FIG. 2 illustrates a state in which a module or model, such as a preprocessing module 131, a first neural network model 133, a second neural network model 135, and a price optimization module 137, or the like, is loaded (or executed) by the processor 130 and is operated in the processor 130.

Referring to FIG. 2, the server 100 may include a communicator 110, a memory 120, and a processor 130.

The communicator 110 may perform various types of communication with various external devices such as the auction server 230 to transmit and receive various information or data (hereinafter, referred to as information).

The first neural network model 133 and the second neural network model 135 may be stored in the memory 120. Each of the first neural network model 133 and the second neural network model 135 is created based on learning (training).

Being created through learning may refer to a predetermined operating rule or artificial intelligence (AI) model set to perform a desired feature is made by making a basic AI model trained using various training data using learning algorithm. The learning may be accomplished through the server 100 in which the AI is performed, or a separate server and/or system, but is not limited thereto. Examples of learning algorithms include, but are not limited to, supervised learning, unsupervised learning, semi-supervised learning, or reinforcement learning, and the algorithm is not limited to the above examples unless otherwise specified.

The memory 120 may pre-store advertisement content of the advertiser 10 desired to be exposed to the consumer through the publisher when the advertiser 10 is successful in the bidding, a bidding period indicating a period in which the advertiser 10 can participate in the bidding, and a bidding budget indicating the total budget to be used for the bidding during the bidding period.

The preprocessing module 131, the price optimization module 137, or the like, may be stored in the storage device in the processor 130 and operated by the processor 130, but this is merely an example, and at least one of the preprocessing module 131 and the price optimization module 137 may be stored in a storage device (e.g., memory 120, etc.) outside of the processor 130.

The processor 130 may receive a bidding request for the advertisement area from the external server 200 managing the advertisement posting for the advertisement area through the communicator 110.

The bidding request for the advertisement area is a message requesting the advertisers to participate in real time bidding performed for the purpose of digital advertisement to the user 20 approaching the corresponding publisher. The bidding request for the advertisement area is a message requesting the advertiser to transmit a price for bidding (i.e., a bidding price) to the advertisement area of the corresponding publisher. Here, the external server 200 may be the auction server 230, but it is not limited thereto.

The processor 130 may determine a bidding price when a bidding request is received, and control the communicator 110 to transmit a bidding price to the external server 200. According to an embodiment, the processor 130 may determine a bidding price using the winning probability distributions output from the first neural network model 133 and the second neural network model 135. Hereinafter, the foregoing will be described in greater detail.

Specifically, the processor 130 may obtain response probability data of the user 20 for the advertisement area based on the user information included in the bidding request through the preprocessing module 131 when a bidding request is received. The processor 130 may obtain noise data through the preprocessing module 131 when a bidding request is received.

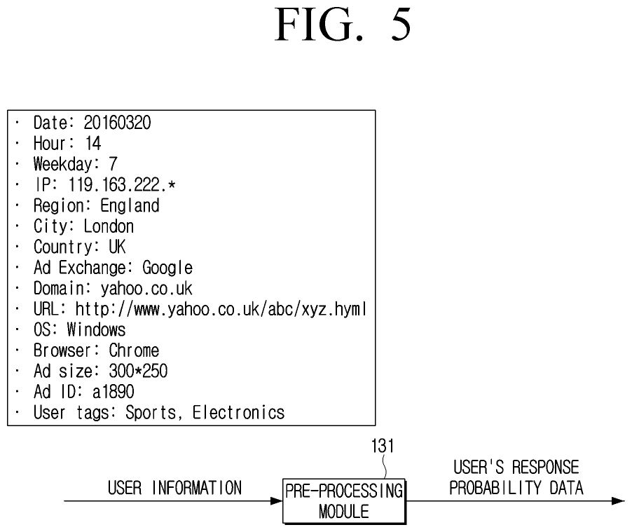

The response probability data of the user 20 may be used as input data of the first neural network model 133. The noise data may be used as input data of the second neural network model 135. A method of obtaining response probability data will be described with reference to FIG. 5. The noise data may represent random data independent of the user information.

FIG. 5 is a diagram illustrating a method for obtaining response probability data of a user according to an embodiment.

Referring to FIG. 5, the input data of the preprocessing module 131 may include user information included in a bidding request, and the output data of the preprocessing module 131 may include response probability data of the user 20. At this time, the pre-processing module 131 may use various types of algorithms or artificial intelligence models, such as logistic regression (LR), follow of the regularized leader (FTRL) proximal, factorization machines (FM), field-aware factorization machines (FFM), gradient boosted decision trees (GBDT), or the like.

The user information included in the bidding request input to the preprocessing module 131 will be described. The user information included in the bidding request indicates information related to the user 20 that accesses the online publisher providing the advertisement area, and when the user 20 accesses the publisher using the terminal device, the information may be collected by the publisher and provided to the external server 200.

According to an embodiment, the user information included in a bidding request may include at least one of gender of the user 20 who accesses on-line publisher providing an advertisement area, date of birth (or age, etc.) of the user 20, a location (e.g., current location, residence, nationality, etc.) of the user 20, the time of access of the user 20, a terminal device used by the user 20 (for example, a type of terminal device, etc.), whether the user 20 is under general data protection regulation (GDPR) (for example, whether providing the personal information of the user 20 is consented, and the range of providing personal information of the user 20), whether the user 20 clicks advertisement, information on the search keyword of the user 20, information on the publisher, information on the advertisement area, or the preference of the user 20 with respect to the advertisement area, or the like.

Here, the information on the publisher may include information about at least one of a type of publisher accessed by the user 20 (e.g., a news feed, a PC application, a mobile application, a messenger, a banner), a category of the publisher (e.g., shopping, electronic, social network service (SNS), game, vehicle, financial, etc.) and a service provider (e.g., Samsung Electronics, or the like) of the publisher. The information on the advertisement area of the publisher may include information on at least one of the type of the advertisement area (e.g., banner advertisement, pop-up advertisement, search advertisement, etc.), the size of the advertisement area (e.g., the horizontal pixel, and the vertical pixel, etc.), the location of the advertisement area, the type of advertisement content posted in the advertisement area (e.g., video, image, keyword, etc.).

For example, as illustrated in FIG. 5, the user information may include date and time of the user's access to the publisher, Internet protocol (IP) address of the terminal device used by the user 20, location of the user 20, uniform resource locator (URL) of the publisher, or the size of the advertisement area, or the like.

The response probability data of the user 20 output from the preprocessing module 131 will be described. The response probability data of the user 20 may indicate data on a probability that the user 20 will respond to an advertisement area in which the advertisement content is posted through the terminal device. The response may mean that the user 20 is responsive to information included in the advertisement content by the user's intent, such as a user input like a click input through a mouse or a touch input through the touch panel. As described above, the response probability data of the user 20 may be an index that predicts a value that may induce a response of the user 20 exposed to the advertisement content when the advertisement content of the advertiser is posted in the advertisement region. The response probability data of the user 20 may be an indicator quantitatively indicating an advertising effect. Meanwhile, the response probability data of the user 20 may be used as input data of the first neural network model 133, which will be described later.

As an example, the response probability data of the user 20 may be a probability between 0 and 1, and more specifically, the response probability data may be a predicted click through rate (P_{ctr}r) for the advertisement impression. That the probability is closer to 1 may mean that the response of the user 20 to the advertisement content (i.e., the success of the advertisement) is likely induced, and that the probability is closer to 0 may mean that the response of the user 20 to the advertisement content is not likely induced (i.e., the failure of the advertisement).

Referring back to FIG. 2, the processor 130 may obtain first winning probability distribution by inputting the response probability data of the user 20 output through the preprocessing module 131 and the auction-related data of the advertiser 10 to the first neural network model 133, and may obtain a second winning probability distribution by inputting the noise data to the second neural network model 135. A concept of a winning probability distribution will be described later.

The processor 130 may obtain the first winning probability distribution by inputting the response probability data of the user 20 and the auction-related data of the advertiser 10 to the first neural network model 133.

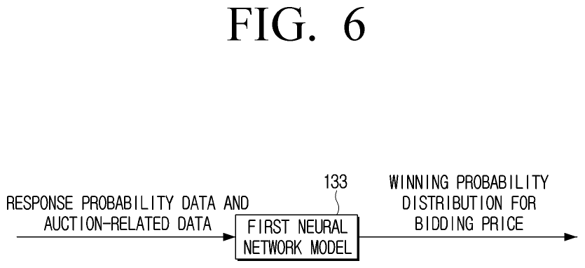

Here, the first neural network model 133 may be an artificial intelligence model trained to predict a winning probability distribution for a bidding price based on the advertisement history data of the advertiser 10. The first neural network model 133 may be trained by a reinforcement learning method, and details thereof will be provided with reference to FIG. 6.

The first neural network model 133 may receive, as an input, response probability data of the user 20 and auction-related data of the advertiser 10. Here, the response probability data of the user 20 overlaps with the above-described contents and thus the redundant description will be omitted.

The auction-related data of the advertiser 10 may include information on at least one of the number of remaining auctions of the bidding period of the advertiser 10 and the amount of remaining budget out of the entire budget of the advertiser 10. The auction-related data of the advertiser 10 may be stored in the memory 120 or included in a bidding request received from the external server 200.

The number of remaining auctions (or a percentage of remaining auctions) during the bidding period of the advertiser 10 refers to the number (or the ratio between the number of auctions processed in the past and the number of auctions to be processed in the bidding period) of remaining auctions based on the current time in the bidding period set so that the advertiser 10 participates in the auction. The amount of budget remaining in the entire budget of the advertiser 10 (or the remaining budget ratio) refers to the amount of budget remaining with reference to the current time from the total budget set by the advertiser 10 to participate in the auction.

The information about remaining budget (or ratio of the currently remaining budget) among the entire budget set by the advertiser 10 and the number (or the ratio of remaining bidding) remaining auctions of the advertiser 10 may be included.

The processor 130 may calculate the remaining budget (or the ratio of the remaining budget) of the advertiser 10 based on the amount of money paid by the advertiser 10 in the previously conducted auction and the bidding budget of the advertiser 10 stored in the memory 120. The processor 130 may calculate a difference between the sum of the amount of money paid by the advertiser 10, which won the auction in the previous auction, and the bidding budget of the advertiser 10 as the remaining budget of the advertiser 10. The processor 130 may divide the remaining budget of the advertiser 10 by the total budget to calculate the ratio of the remaining budget of the advertiser 10.

For example, if it is assumed that the bidding budget of the advertiser 10 is set to 20 million won (South Korean currency (KRW)), and the advertiser 10 who has won previous auctions during the bidding period pays for 3 million won as the winning price, the remaining budget of the current advertiser 10 may be calculated as 17 million won by subtracting the sum of the winning price from the bidding budget. The ratio of the remaining budget of the advertiser 10 may be calculated to be 0.85, which is the value obtained by dividing the remaining budget by the bidding budget.

The processor 130 may calculate the number of remaining auctions (or the ratio of remaining auctions) of the advertiser 10 based on the bidding period of the advertiser 10 stored in the memory 120 and the current time.

The processor 130 may calculate a remaining period excluding a period of time that has elapsed from a bidding period to a current time. The processor 130 may divide the remaining period into a unit time (e.g., day, 1-hour unit, date, etc.), multiply the access number of the user 20 with respect to the publisher per unit time at each time, and then calculate the summed value as the number of remaining auctions of the advertiser 10. Here, the user's access number for the publisher per unit time may represent information of aggregating the number of access (that is, the number of times of auctions) of the user (user 20 or unspecified number of users) to the corresponding publisher for each unit time, and may be received from the external server 200. In this way, the processor 130 may calculate the total number of auctions for the bidding period of the advertiser 10, and the processor 130 may divide the number of remaining auctions by the number of the entire auctions of the advertiser 10 to calculate the ratio of the remaining auctions of the advertiser 10.

For example, if it is assumed that the bidding period of the advertiser 10 is set to Jul. 10, 2020 (Friday) to Jul. 12, 2020 (Sunday), and the current time is Jul. 11, 2020 (Saturday), the period remaining in the bidding period may be calculated as a period from Jul. 11, 2020 to Jul. 12, 2020. If it is assumed that 10,000 auctions are generated on Friday; 25,000 auctions is generated on Saturday; and 15,000 auctions occur on Sunday from the past history data, the number of predicted bidding during the remaining period is calculated as 40,000 which is obtained by adding the number of access of the user for each unit time corresponding to the remaining period (that is, Jul. 11, 2020 to Jul. 12, 2020), and the predicted total number of auctions during the bidding period may be calculated as 50,000 by adding the number of user's access for each unit time corresponding to the bidding period (that is, a period from Jul. 10, 2020 to Jul. 12, 2020). In this case, the processor 130 may divide the number of remaining auctions by the number of the total auctions to calculate the ratio of the remaining auctions of the advertiser 10 as 0.8.

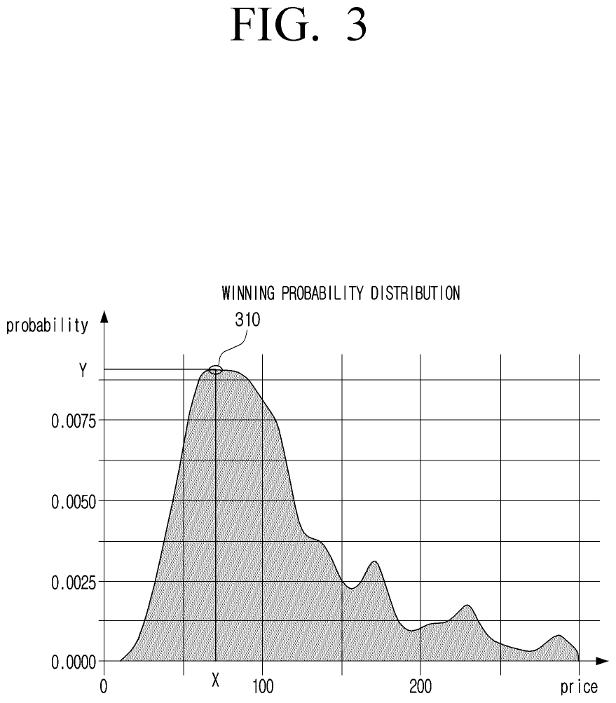

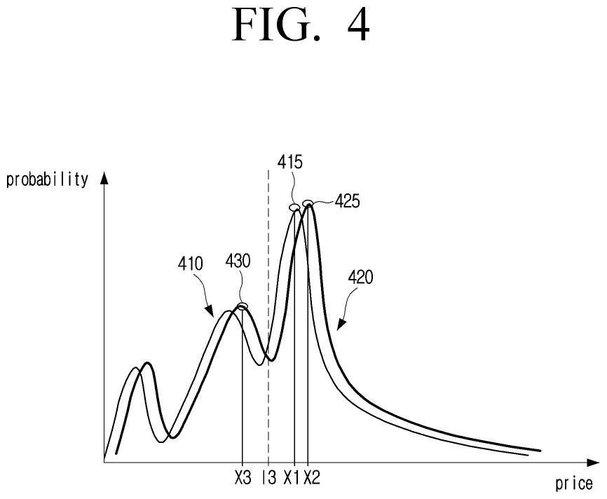

In the first neural network model 133, first winning probability distribution may be output. A concept of the winning probability distribution will be described with reference to FIG. 3.

FIG. 3 is a diagram illustrating a winning probability distribution according to an embodiment.

Referring to FIG. 3, the winning probability distribution is determined by considering a value (e.g., advertising effect during the entire bidding period, etc.) of the entire auction (or remaining auction) as well as the corresponding auction (auction which receives a current bidding request), and may refer to probability distribution of winning for a bidding price having a range from a minimum price to a maximum price. The concept of the winning probability distribution for the bidding price may be equally applied to the first winning probability distribution output from the first neural network model 133 and the second winning probability distribution output from the second neural network model 135.

For example, the winning probability distribution for a bidding price may refer to a function in which x axis represents a bidding price (or ratio of a bidding price) and an y axis represents probability (or winning probability), as shown in FIG. 3. The minimum price is 0 (e.g., 0 won, 0 dollar, etc.), and the maximum bidding price may correspond to the amount of the remaining budget of the advertiser 10. That is, if the amount of the remaining budget of the advertiser 10 is reduced due to the winning bid of the advertiser 10 as the auction proceeds, the maximum bidding price may also be reduced. There may be a particular point 310 having the highest probability Y among the plurality of points included in the winning probability distribution of FIG. 3, which may indicate that the bidding price should be determined by the amount X of the particular point 310 in the corresponding bidding to maximize the advertising effect at the entire auctions (or remaining auctions).

Referring back to FIG. 2, the processor 130 may obtain the second wining probability distribution by inputting the noise data to the second neural network model 135.

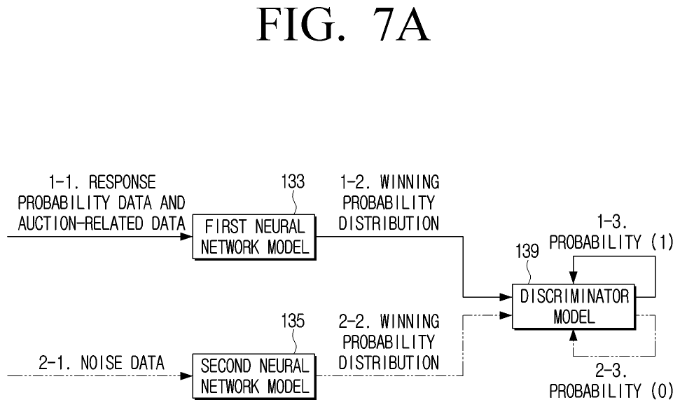

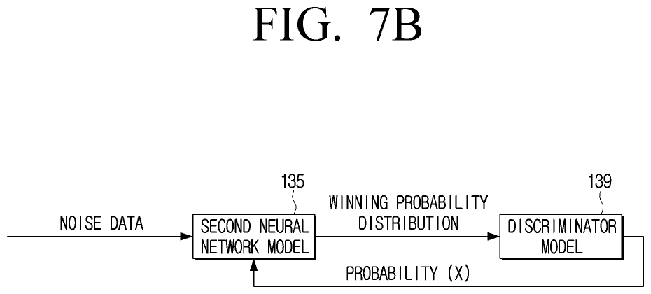

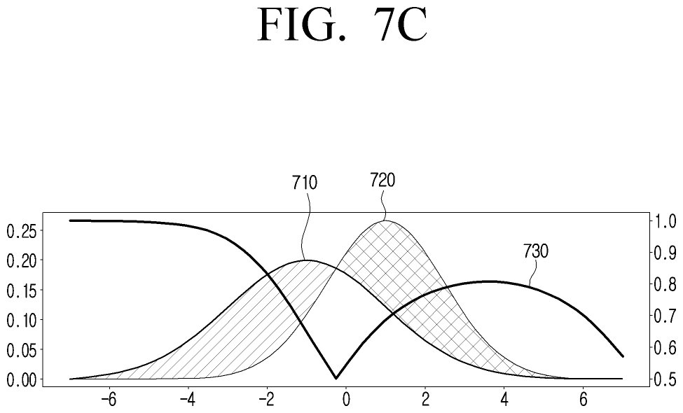

The second neural network model 135 may be an artificial intelligence model trained so that the winning probability output from the first neural network model 135 based on the noise data has a degree of approximation with the winning probability output from the first neural network model 133 that exceeds a threshold value. The second neural network model 135 may be trained by generative adversarial networks (GAN) method, and the detailed description will be described with reference to FIGS. 7A to 7C.

The noise data to be input to the second neural network model 135 will be described. The noise data refers to random data. The noise data may be a random value (e.g., a value between 0 and 1) according to the Gaussian distribution.

According to an embodiment, the noise data may be data in the same type as the type of the data input to the first neural network model 133.

For example, the noise data may include a random value (e.g., a value between 0 and 1) for the response probability data of the user 20. The noise data may also include a random value (e.g., a value between 0 to 1) for a ratio of remaining budget and a random value (e.g., a value between 0 to 1) for the ratio of remaining bidding.

According to another example, the noise data may include a random value for the response probability data of the user 20, the remaining budget, and the number of remaining auctions. In this example, the random value for the response probability data of the user 20, remaining budget, and the number of remaining auctions may be input to the second neural network model 135, and the remaining budget and the number of remaining auctions may be the same data as the data input to the first neural network model 133.

This is merely an example, and the noise data may be random data in a type different from the type of the data input to the first neural network model 133.

The second winning probability distribution may be output from the second neural network model 135. This is redundant with the description of FIG. 3 and a further description will be omitted.

The processor 130 may identify a bidding price or bidding price for the advertiser 10 based on the first winning probability distribution and the second winning probability distribution through the price optimization module 137.

The bidding price for the advertiser 10 identified by the processor 130 may be a final bidding price proposed by the advertiser 10 in the auction for which bidding request is received.

Specifically, the processor 130 may identify the bidding price with the highest probability in the first winning probability distribution and the second winning probability distribution as a bidding price for the advertiser 10 through the price optimization module 137. A specific embodiment will be described with reference to FIG. 4.

FIG. 4 is a diagram illustrating a method for determining a final bidding price according to an embodiment.

Referring to FIG. 4, for example, the processor 130 may compare the probability value of a point 415 having the highest probability value in the first winning probability distribution 410 and the probability value of a point 425 having the highest probability value in the second winning probability distribution to identify the amount (e.g., X2) of the point (e.g., 425) having a higher probability value as the final bidding price for the advertiser 10.

For example, it is assumed that the probability value of the point 415 having the highest probability value among the plurality of points included in the first winning probability distribution 410 is 0.6 and the bidding price is 150 won, and the probability value of the point 425 having the highest probability value among the plurality of points included in the second winning probability distribution 420 is 0.75 and the bidding price is 160 won. In this example, the processor 130 may identify the bidding price 160 won of the point X2 having the highest probability value among the first winning probability distribution 410 and the second winning probability distribution 420 as a bidding price for the advertiser 10.

The processor 130 may control the communicator 110 to transmit the identified bidding price for the advertiser 10 to the external server 200. The processor 130 may control the communicator 110 to transmit the bidding price and the information on the advertiser 10 to the external server 200. In this example, when the bidding price for the advertiser 10 is transmitted, the external server 200 may select an advertiser identified as transmitting the highest price among the at least one transmitted bidding price as a winning bidder.

As described above, the server 100 according to an embodiment may flexibly determine a bidding price corresponding to a market situation that dynamically varies due to competition between models using random noise data having a diversity of behavior. Accordingly, the advertising effect of the advertiser 10 may be maximized through the optimized bidding price.

Various other embodiments will be described below.

FIG. 6 is a diagram illustrating a method of training a first neural network model according to an embodiment.

Referring to FIG. 6, the first neural network model 133 may be trained to output a winning probability distribution for a bidding price through learning data according to reinforcement learning (RL). The first neural network model 133 may be trained by the processor 133 of the server 100 or trained by an external device.

The learning data of the first neural network model 133 may include advertisement history data of the advertiser 10. Here, the advertisement history data refers to history data for a bidding request accumulated during a past bidding period that the advertiser 10 has set to participate in the bidding.

According to an embodiment, the advertisement history data may include information about a click rate representing the number of clicking of advertisement with respect to the time of impression of the advertisement when the advertiser 10 posts an advertisement in the advertisement area, the number of participation of the advertiser in the auction during a preset period, the number of winning of bidding by the advertiser, winning bidding price, budget of the advertiser for a preset period. The advertisement history data may include auction-related data received or obtained by the advertiser 10 during the past bidding period or response probability data of the user 20. In the learning stage, the data input or output to the first neural network model 133 may have the same type as the data input or output to the first neural network model 133 in the prediction stage as illustrated in FIG. 2.

A reinforcement learning method may refer to a method in which an agent recognizes a current state in a predetermined environment and trains a neural network model to maximize a reward through an action which the agent performs. For example, the reinforcement learning method may be a method such as a Markov Decision Process (MDP) or a Constrained Markov Decision Process (CMDP)-deep RL (DRL), which is a process of modeling a decision making process designed based on the first-order Markov assumption that “a state oft at a point in time (time) is influenced only by the state of the point in time t-1”, but is not limited thereto, and may be a variety of methods such as Q-Learning, Deep Q-Network (DQN), Deep RL, etc.

Referring to the relationship of three elements of a state, a reward, and an action, when the agent that is subject to an action in the current state (Sₜ) of the environment does a particular action (Aₜ), the environment may have a modified state (Sₜ₊₁) and the agent may have a relationship to receive a compensation (Rₜ).

The learning data used for learning of the reinforcement learning method may include data related to each auction that was performed in the past and response probability data of the user 20. That is, the learning data is different from the input data of the first neural network model 133 in terms of a point in time in that the type of the learning data is the same as the input data of the first neural network model 133 described above, but the learning data is related to the past auction.

The learning data may include data on the current state (Sₜ), the reward (Rₜ), and the action (Aₜ) at a time point t. The learning data may further include data for the next state (Sₜ+1) at a time point (t+1), which is the next point in time that is changed by the action (Aₜ).

The current state Sₜ may be information about the current environment measured by the agent. For example, the current state Sₜ may include the auction-related data of the advertiser 10 (e.g., the rate of remaining budget, the rate (or numbers) of remaining auctions, etc.) and the response probability data of the user 20 (e.g., predicted click through rate Pₐr, etc.) based on the time at which the corresponding auction was progressed (e.g., the ratio of the remaining budget, the rate of remaining auctions, etc.) and the response probability data (e.g., advertisement impression) of the user 20. The next state (Sₜ-pi) may indicate the next state of the current state (Sₜ) that is changed by the action (Aₜ).

The action (Aₜ) may include a predicted winning bidding price (or predicted bidding price) at the corresponding auction. The reward Rₜ may indicate the probability data that the user 20 exposed to the advertisement content of the winner of the auction may respond.

The meaning that the reinforcement learning maximizes a target reward may mean maximizing the sum of the rewards according to each action performed at various times during the bidding period, instead of maximizing reward Rₜ according to the single action Aₜ the current time t.

The first neural network model 133 may be trained in a unit of an advertiser. If there is no data related to the past auction of the advertiser 10 (i.e., the new advertiser), the first neural network model 133 of the advertiser 10 may be trained using the history data of other advertisers belonging to the same category (e.g., sports) as the learning data.

FIGS. 7A and 7C are diagrams illustrating a method of training a second neural network model according to an embodiment.

Referring to FIGS. 7A to 7C, the processor 130 may train the second neural network model 135 using a discriminator model 139 according to a generative adversarial threat (GAN) learning method. The discriminator model 139 and the second neural network model 135 are in a mutually adversarial relationship, and the discriminator model 139 and the second neural network model 135 may alternately be trained. The second neural network model 135 and the discriminator model 139 may be trained in units of advertiser.

In one embodiment, the discriminator model 139 may be trained by the processor 130 of the server 100 and stored in the memory 120. However, the discriminator model 139 may be trained in an external device. The second neural network model 135 may be trained by the processor 130 or the external device of the server 100. Hereinafter, it is assumed that the discriminator model 139 is trained by the server 100 and the embodiment will be described in detail.

Referring to FIG. 7A, the discriminator model 139 may be a model trained to output a probability value for a level of approximation of the winning probability distribution output from the first neural network model 133 and the winning probability distribution output from the second neural network model 135.

The second neural network model 135, which is a generator model, may generate fake data that is closer to the real data through the learning, so as to train the discriminator model 139 by using the fake data generated by the second neural network model 135 as the real data. The discriminator model 139 may develop the ability to distinguish (discern) the authenticity of the data by learning the real data and the fake data.

Specifically, the discriminator model 139 is an artificial intelligence model that operates as a discriminator capable of discriminating data by identifying whether the data input to the discriminator model 139 is real data or fake data. The data output from the discriminator model 139 may be a probability (e.g., a value between 0 and 1) that the data input to the discriminator model 139 will correspond to the real data (or fake data). The data output from the discriminator model 139 may be a probability (e.g., a value between 0 and 1) indicating how the data input to the discriminator model 139 approximates the real data. In the disclosure, real data may be set to a winning probability distribution for a bidding price output from the first neural network model 133, and the fake data may be set to a winning probability distribution for a bidding price output from the second neural network model 135.

The discriminator model 139 may be trained to identify the winning probability distribution for the bidding price input to the discriminator model 139 as real data when the winning probability distribution for the bidding price output from the first neural network model 133 is input to the discriminator model 139. The discriminator model 139 may be trained to identify the winning probability distribution for the bidding price input to the discriminator model 139 as the fake data when the winning probability distribution for the bidding price output from the second neural network model 135 is input to the discriminator model 139.

For example, the discriminator model 139 may be trained to output a probability value of 1 representing the real data when the winning probability distribution for the bidding price output from the first neural network model 133 is input. The discriminator model 139 may be trained to output a probability value of 0 representing the fake data when the winning probability distribution for the bidding price output from the second neural network model 135 is input.

As described above, the first neural network model 133 used for training the discriminator model 139 is an artificial intelligence model in which learning is completed in a manner such as reinforcement learning, and the winning probability distribution for the bidding price outputted from the first neural network model 133 may be data related to each auction that was performed in the past and data output when the response probability data of the user 20 is input. The second neural network model 135 used for training the discriminator model 139 may be an artificial intelligence model trained at a point in time which is immediately prior to the current point in time.

Referring to FIG. 7B, when noise data is input, the second neural network model 135 may operate as a generator to output (generate) a winning probability distribution for a bidding price. Here, the noise data represents random data in the Gaussian distribution as described above.

The second neural network model 135 may be trained to so that the wining probability distribution for the bidding price output from the second neural network model 135 simulates a winning probability distribution for a bidding price output from the first neural network model 133. The second neural network model 135 may be trained so that the winning probability distribution output from the second neural network model 135 has a probability distribution that approximates the winning probability distribution output from the first neural network model 133.

The second neural network model 135 may be trained to output a winning probability distribution of which the approximation degree with respect to the winning probability distribution output from the first neural network model 133 exceeds a threshold value. The second neural network model 135 may be trained such that the approximation degree of the winning probability distribution output from the second neural network model 135 and the approximation degree of the winning probability distribution output from the first neural network model 133 exceeds a threshold value.

Here, the approximation degree of the winning probability distribution output from the second neural network model 135 and the degree of approximation of the winning probability distribution output from the first neural network model 133 may be identified through a probability value (e.g., a value between 0 and 1) output to the discriminator model 139. The threshold value may be set to 0.9, for example, but it is only one embodiment, and the value may be set to various values.

The first neural network model 133 used for learning of the second neural network model 135 is an artificial intelligence model in which learning is completed in a manner such as reinforcement learning, and the winning probability distribution for the bidding price outputted from the first neural network model 133 may be data related to each auction that was performed in the past and data output when the response probability data of the user 20 is input. The discriminator model 139 used for training of the second neural network model 135 may be an artificial intelligence model trained at the point in time just before the current time point.

As shown in FIG. 7C, the discriminator model 139 and the second neural network model 135 may be alternately trained to minimize a difference 730 (or the area of the difference) between the winning probability distribution 710 output from the first neural network model 133 representing the real distribution and the winning probability distribution 720 output from the second neural network model 135 representing the generated distribution. The difference 730 may correspond to an approximation degree of the winning probability distribution output from the second neural network model 135 and the winning probability distribution output from the first neural network model 133. For example, as the difference 730 (or the area of the difference) decreases, the approximation degree of the winning probability distribution output from the second neural network model 135 and the winning probability distribution output from the first neural network model 133 may be increased.

The second neural network model 135, which is trained as described above, may flexibly respond to a new situation when the new situation that deviates from the tendency of the history data of the advertisement market such as the inflow of a new user may occur, to determine an optimal bidding price.

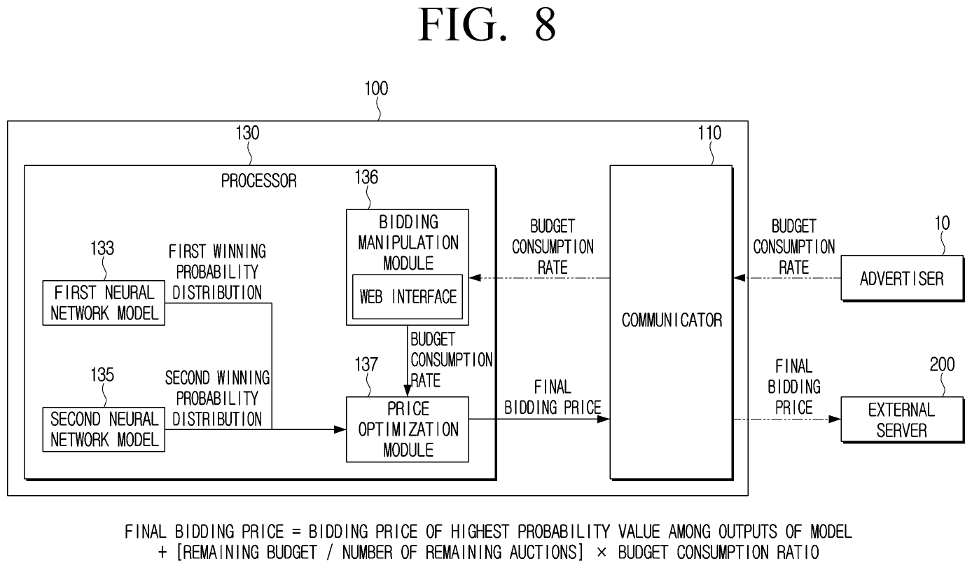

FIG. 8 is a diagram illustrating an embodiment in which intervention of an advertiser in a final bidding price is possible according to an embodiment. The bidding manipulation module 136 of FIG. 8 may refer to a state of loading (or executing) and operating by the processor 130.

Referring to FIG. 8, the server 100 according to an embodiment may provide a system capable of intervening of an advertiser in a final bidding price determination. The bidding operation module 136 may be stored in the processor 130 or the memory 120 of the server 100.

In an embodiment, the processor 130, when information about a budget consumption ratio of the advertiser 10 is received through the communicator 110, may store the information about the budget consumption ratio in the memory 120.

The budget consumption ratio refers to a parameter for adjusting the bidding price determined in the remaining bidding of the advertiser 10, and the budget consumption ratio may be mapped to a predetermined value according to the level. For example, as the budget consumption ratio, a predetermined value of 0.2 may be mapped to level 1, and a predetermined value of 0.3 may be mapped to level 2. The information on the budget consumption ratio may be received from the terminal device of the advertiser 10.

Afterwards, the auction may proceed, and the processor 130, upon receiving a bidding request for the advertisement area from the external server 200 through the communicator 110, may obtain response probability data of a user for the advertisement area based on the user information included in the bidding request, input the auction-related data of the advertiser 10 and the response probability data of the user to the first neural network model 133 to obtain the first winning probability distribution, and may input the noise data to the second neural network model 135 to obtain the second winning probability distribution.

The processor 130 may identify a bidding price based on a budget consumption ratio stored in the memory 120 and the first and second winning probability distributions. The bidding price may be calculated based on, for example, Equation 1.

[Equation 1]

Bidding price=[bidding price of the highest probability value among the first and second winning probability distributions output from the first neural network model 133 and the second neural network model 135]+{[remaining budget/the number of remaining auctions]×budget consumption ratio}.

The processor 130 may control the communicator 110 to transmit the identified bidding price to the external server 200.

According to another embodiment, the processor 130 may store information on the maximum amount of payment per auction in the memory 120 when the information on the maximum payment amount per auction of the advertiser 10 is received through the communicator 110. The maximum amount of payment per auction indicates the maximum limit amount that may be determined as a bidding price in one auction, and the information on the maximum amount of payment per auction may be received from the terminal device of the advertiser 10.

Afterwards, if the auction is proceeded, and the processor 130 receives the bidding request for the advertisement area from the external server 200 through the communicator 110, the processor 130 may obtain response probability data of a user for the advertisement area based on the user information included in the bidding request, input the auction-related data of the advertiser 10 and the response probability data of the user to the first neural network model 133 to obtain a first winning probability distribution, and input the noise data to the second neural network model 135 to obtain a second winning probability distribution.

The processor 130 may identify a bidding price having the highest winning probability within a range of the maximum amount of payment stored in the memory 120 among the winning probability for each bidding price based on the first and second winning probability distributions obtained from the first and second neural network models 135.

For example, among a plurality of points included in the first winning probability distribution 410 and the second winning probability distribution 420 in FIG. 4, a point 425 of the highest probability value in the total range of the price may have a probability value of 0.75 at a price of 200 won (X2), and a point 430 of the highest probability value equal to or below the maximum payment amount of 150 won (13) may have a probability value of 0.4 at a price of 120 won (X3). In this case, the processor 130 may identify a 120 won, which is the price (X3) of the point 430 having the highest winning probability value, from among the first and second winning probability distributions obtained from the first and second neural network models 133 and 135, as a bidding price in the range within the maximum payment amount (13).

The processor 130 may control the communicator 110 to transmit the identified bidding price to the external server 200.

As described above, the server 100 according to an embodiment may provide an environment in which the advertiser 10 may not only automatically predict a bidding price based on the bidding period and the budget setting by the advertiser 10, but also intervention of the advertiser 10 is available as to how much bidding price would be consumed even in an environment in which the bidding period and the budget, or the like, is identical.

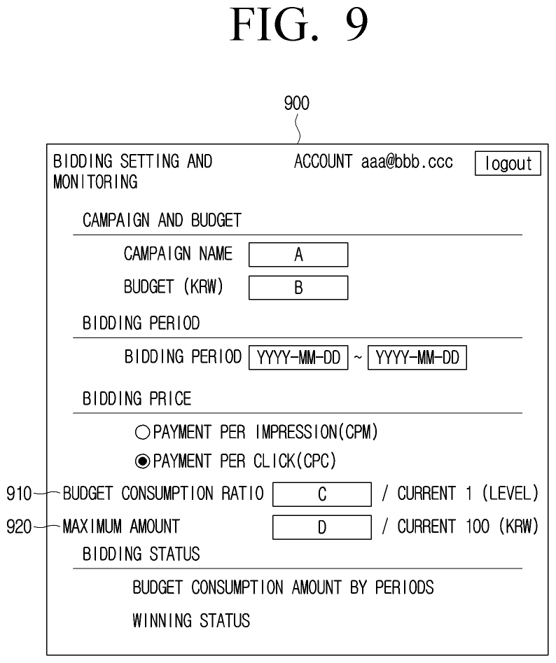

FIG. 9 is a diagram illustrating a user interface (UI) provided to an advertiser according to an embodiment.

Referring to FIG. 9, the server 100 according to an embodiment may provide a user experience interface (UI) 900 to a terminal device of the advertiser 10. For example, when the server 100 receives account information of the advertiser 10 from the terminal device of the advertiser 10 through the communicator 110, the server 100 may transmit the UI 900 to the terminal device of the advertiser 10 to be displayed on the terminal device of the advertiser 10.

The UI 900 provided to the terminal device of the advertiser 10 may include various information such as an item for setting a bidding of the advertiser 10 and an item for notifying a bidding status. For example, the UI 900 may include an item for setting a campaign name, an item for setting a bidding budget, an item for setting a bidding period, an item for setting a bidding price, an item 910 for setting a budget consumption ratio, an item 920 for setting a maximum payment amount per auction, a bidding status, a budget consumption for each period, and information on the bid status.

The item set in the terminal device of the advertiser 10 may be transmitted to the server 100. In this example, the server 100 may change a bidding setting (e.g., a bidding period, a budget consumption ratio, a maximum payment amount, etc.) of the advertiser 10 according to an item received through the communicator 110.

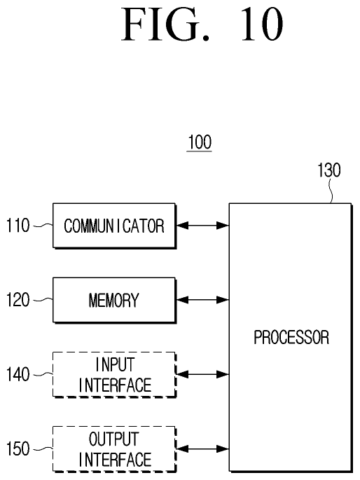

FIG. 10 is a block diagram illustrating an additional configuration of a server according to an embodiment.

Referring to FIG. 10, the server 100 according to an embodiment may further include at least one of the input interface 140 and the output interface 150, in addition to the communicator 110, the memory 120, and the processor 130.

The communicator 110 may communicate with various external devices such as the external server 200 to transmit or receive information. The communicator 110 may include a circuit for performing various types of communication (e.g., WiFi, Bluetooth, ZigBee, etc.).

The memory 120 is configured to store various data related to elements of the electronic apparatus 100 and an operating system (OS) for controlling overall operations of the elements of the server 100.

The memory 120 may include hardware that temporarily or permanently stores data or store. For example, the memory 120 may be implemented as at least one hardware among a non-volatile memory, a volatile memory, a flash memory, a hard disk drive (HDD) or solid state drive (SSD), random access memory (RAM), read-only memory (ROM), or the like.

The memory 120 may store at least one instruction, program, or data used for operation of the server 100 or the processor 130. The instruction is a code unit that directs the operation of the electronic apparatus 100 or the processor 130, and may be written in a machine language that can be understood by a computer. A program may be an instruction set of a series of instructions that perform a particular task of a task unit. The data may be status information in bit unit or byte unit that may represent characters, numbers, images, or the like.

The processor 130 may be implemented as a general-use processor such as a central processing unit (CPU), an application processor (AP), a graphics-only processor such as a graphics processing unit (GPU), a vision processing unit (VPU), or the like, or an artificial intelligence (AI)-only processor such as a neural processing unit (NPU). The processor 130 may include a volatile memory for loading at least one instruction or module.

The input interface 140 may receive various user commands and pass the same to the processor 130. The processor 130 may recognize a user command input from a user through the input interface 140. Here, the user command may be implemented in various ways, such as a user's touch input (e.g., via a touch panel), a key (e.g., via a keyboard) or a button (e.g., via physical button or a mouse, etc.) input, user voice (e.g., via a microphone), or the like.

The output interface 150 is configured to output information and may be implemented as, for example, a display, a speaker, or the like. The display is a device that visually outputs information or data. The display may display an image frame in all or a portion of the display area that may be driven in a pixel unit. At least a portion of the display may be coupled to at least one of a front area and a side area and a back area of the server 100 in the form of a flexible display. The flexible display may be characterized as being bent, curved, or rolled without a damage through a paper-like thin and flexible substrate. The speaker may directly output various notification sound or voice messages as well as various audio data for which various processing has been performed, such as decoding or amplification, noise filtering, etc., by an audio processor (not shown) as voice.

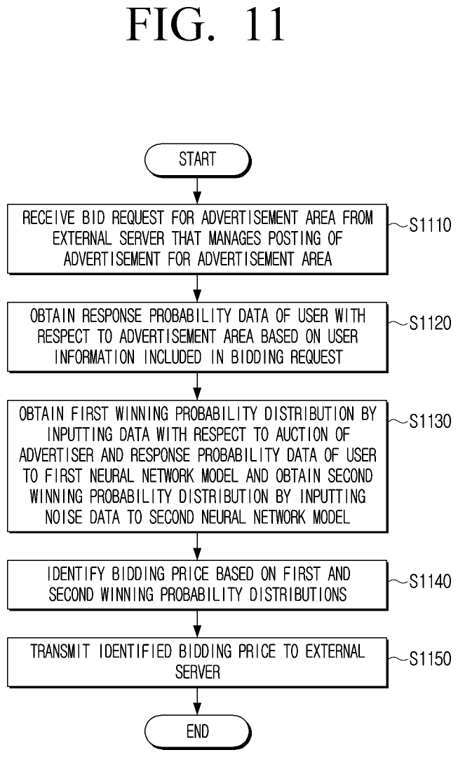

FIG. 11 is a flowchart illustrating a method for controlling a server according to an embodiment.

Referring to FIG. 11, the method for controlling the server 100 according to an embodiment may include receiving a bid request for an advertisement area from the external server 200 that manages posting an advertisement for an advertisement area in operation S1110; obtaining response probability data of the user 20 with respect to the advertisement area based on user information included in the bidding request in operation S1120; obtaining a first winning probability distribution by inputting data with respect to an auction of an advertiser and response probability data of the user 20 to the first neural network model 133 and obtaining a second winning probability distribution by inputting noise data to the second neural network model 135 in operation S1130; identifying a bidding price based on the first and second winning probability distributions in operation S1140; and transmitting the identified bidding price to the external server 200 in operation S1150.

The method for controlling the server 100 may include receiving a bidding request for an advertisement area from the external server 200 for managing advertisement posting for the advertisement area in operation S1110.

The response probability data of the user 20 for the advertisement area may be obtained based on the user information included in the bidding request in operation S1120.

The user information included in the bidding request may include, for example but not limited to, information about at least one of gender of the user (or potential consumer) 20 who accesses with an on-line publisher providing the advertisement area, a date of birth of the user 20, a location of the user 20, a time of access of the user 20, a terminal device used by the user 20, whether the user 20 is under general data protection regulation (GDPR), whether the user 20 clicks an advertisement, a search keyword of the user 20, information on the publisher, information on the advertisement area, or the preference of the user 20 with respect to the advertisement area.

The auction-related data of the advertiser 10 and the response probability data of the user 20 may be input to the first neural network model 133 to obtain a first winning probability distribution, and the noise data may be input to the second neural network model 135 to obtain a second winning probability distribution in operation S1130.

The auction-related data of the advertiser 10 may include information about at least one of a number of remaining auctions during a bidding period of the advertiser 10 and an amount of a remaining budget out of an entire budget of the advertiser 10.

According to an embodiment, the first neural network model 133 may be trained to predict winning probability distribution for a bidding price based on advertisement history data of the advertiser 10.

The advertisement history data may include, based on the advertiser 10 posting an advertisement in an advertisement area, information about a click rate indicating a number of clicks of the advertisement with respect to a number of impression of the advertisement, a number of participations of the advertiser 10 in an auction during a preset period, a number of winning by the advertiser 10, a winning price, and a budget of the advertiser 10 during the preset period.

According to an embodiment, the second neural network model 135 may be trained to output a winning probability distribution, of which an approximation degree with a winning probability distribution output from the first neural network 133 exceeds a threshold value.

According to an embodiment, the second neural network model 135 may be a generator model in which a probability value output from a discriminator model exceeds the threshold value, and the discriminator model may be trained to output a probability value for an approximation degree of the first winning probability distribution output from the first neural network model 133 and the second winning probability distribution output from the second neural network model 135.

The bidding price may be identified based on the first and second wining probability distributions in operation S1140. The transmitting the identified bidding price to the external server 200 in operation S1150 may be included.

The identifying and the transmitting in S1140 and S1150 may include identifying a bidding price that has a highest winning probability among winning probabilities for respective bidding prices based on the first and second winning probability distributions obtained from the first network model 133 and the second neural network model 135, and transmitting the identified bidding price to the external server 200.

The method according to an embodiment may include, based on receiving information about a budget consumption ratio of the advertiser 10, storing the information about the budget consumption ratio in the memory 120 of the server 100. In the identifying and transmitting in operations in S1140 and S1150, the method may include identifying a bidding price based on the first and second winning probability distributions and the stored budget consumption ratio, and transmitting the identified bidding price to the external server 200.

The method according to an embodiment may further include, based on receiving information about a maximum payment amount of the advertiser 10, storing the information about the maximum payment amount per auction in the memory 120 of the server 100. The identifying and transmitting in operations S1140 and S1150 may include identifying a bidding price having a highest winning probability within a range of the maximum payment amount among the winning probabilities by bidding prices based on the winning probability distribution obtained from the first neural network model 133 and the second neural network model 135, and transmitting the identified bidding price to the external server 200.

The server 100 according to various embodiments may be implemented as at least one of smartphones, tablet PCs, mobile phones, video telephones, electronic book readers, desktop personal computers (PCs), laptop PCs, netbook computers, workstations, servers, a portable digital assistant (PDA), a portable multimedia player (PMP), an MP3 player, a medical device, a camera, or a wearable device. According to various embodiments, a wearable device may include any one or any combination of the accessory type (e.g., as a watch, a ring, a bracelet, a bracelet, a necklace, a pair of glasses, a contact lens or a head-mounted-device (HMD)); a fabric or a garment-embedded type (e.g., a skin pad or a tattoo); or a bio-implantable circuit. The server 100 may be a home appliance. The home appliance may include at least one of, for example, a television, a digital video disk (DVD) player, an audio system, a refrigerator, air-conditioner, a cleaner, an oven, a microwave, a washing machine, an air purifier, a set top box, a home automation control panel, a security control panel, a publisher box (e.g., SAMSUNG HOMESYNC^{m}, APPLE TV™, or GOOGLE TV™), a game console (e.g., XBOX™, PLAYSTATION™), an electronic dictionary, an electronic key, a camcorder, or an electronic frame. The server 100 according to an embodiment is not limited to the devices described above and may include a new electronic device according to technology development.

The various embodiments described above may be implemented as software including instructions stored in a machine-readable storage publisher which is readable by a machine (e.g., a computer). The device may include the electronic device (e.g., server 100) according to the disclosed embodiments, as a device which calls the stored instructions from the storage publisher and which is operable according to the called instructions. When the instructions are executed by a processor, the processor may directory perform functions corresponding to the instructions using other components or the functions may be performed under a control of the processor. The instructions may include code generated or executed by a compiler or an interpreter. The machine-readable storage publisher may be provided in a form of a non-transitory storage publisher. The ‘non-transitory’ means that the storage publisher does not include a signal only and is tangible, but does not distinguish (or limit) whether data is stored semi-permanently or temporarily in the storage publisher.

According to various embodiments, a method according to one or more embodiments may be provided included a computer program product. The computer program product may be exchanged between a seller and a purchaser as a commodity. The computer program product may be distributed in the form of a machine-readable storage publisher (e.g., a compact disc read only memory (CD-ROM)), or distributed online through an application store (e.g., PLAYSTORE™). In the case of online distribution, at least a portion of the computer program product (e.g., downloadable app) may be at least stored temporarily in a storage publisher such as a server of a manufacturer, a server of an application store, or a memory of a relay server, or temporarily generated.

Further, each of the components (e.g., modules or programs) according to the various embodiments described above may include a single entity or a plurality of entities, and some subcomponents of the above-mentioned subcomponents may be omitted or the other subcomponents may be further included to the various embodiments. Generally, or additionally, some components (e.g., modules or programs) may be integrated into a single entity to perform the same or similar functions performed by each respective component prior to integration. Operations performed by a module, a program, or other component, according to various embodiments, may be sequential, parallel, or both, executed iteratively or heuristically, or at least some operations may be performed in a different order, omitted, or other operations may be added.

At least one of the components, elements, modules or units described herein may be embodied as various numbers of hardware, software and/or firmware structures that execute respective functions described above, according to an example embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the block diagrams, communication between the components, elements or units may be performed through the bus. Functional aspects of the above example embodiments may be implemented in algorithms that execute on one or more processors. Furthermore, the components, elements or units represented by a block or processing operations may employ any number of related art techniques for electronics configuration, signal processing and/or control, data processing and the like.

While the disclosure has been particularly shown and described with reference to embodiments thereof, it will be understood that various changes in form and details may be made therein without departing from the spirit and scope of the following claims.

What is claimed is:

1. A server comprising:
a communication interface;
a memory configured to store a first neural network model and a second neural network model, the first neural network model being trained to predict a first winning probability distribution for a bidding price based on advertisement history data of an advertiser and the second neural network model being trained to output a second winning probability distribution, an approximation degree between the first winning probability distribution output from the first neural network model and the second winning probability distribution exceeding a threshold value; and
a processor configured to:
based on receiving, through the communication interface, a bidding request for an advertisement area from an external server that manages posting, on a network, an advertisement for the advertisement area, obtain response probability data of a user based on user information included in the bidding request, the response probability data indicating a probability of the user, when exposed to the advertisement, responding to the advertisement posted in the advertisement area;
obtain the first winning probability distribution by inputting, to the first neural network model, auction-related data of the advertiser and the response probability data of the user, and obtain the second winning probability distribution by inputting noise data to the second neural network model; and
identify a bidding price based on the first and second winning probability distributions and control the communication interface to transmit the identified bidding price to the external server, upon which a winning advertiser whose advertisement is to be posted in the advertisement area is determined.

2. The server of claim 1, wherein the second neural network model is a generator model in which a probability value output from a discriminator model exceeds the threshold value, and
wherein the discriminator model is trained to output a probability value for the approximation degree between the first winning probability distribution output from the first neural network model and the second winning probability distribution output from the second neural network model.

3. The server of claim 1, wherein the processor is further configured to identify a bidding price that has a highest winning probability among winning probabilities for respective bidding prices based on the first and second winning probability distributions obtained from the first and second neural network models, and control the communication interface to transmit the identified bidding price to the external server.

4. The server of claim 1, wherein the processor is further configured to:
based on receiving information about a budget consumption ratio of the advertiser through the communication interface, store the information about the budget consumption ratio in the memory; and
identify the bidding price based on the first and second winning probability distributions and the stored budget consumption ratio, and control the communication interface to transmit the identified bidding price to the external server.

5. The server of claim 1, wherein the processor is further configured to:
based on receiving information about a maximum payment amount of the advertiser through the communication interface, store the information about the maximum payment amount per auction in the memory; and
identify a bidding price having a highest winning probability within a range of the maximum payment amount among winning probabilities for respective bidding prices based on the first and second winning probability distributions obtained from the first and second neural network models, and control the communication interface to transmit the identified bidding price to the external server.

6. The server of claim 1, wherein the advertisement history data comprises, based on the advertiser posting a previous advertisement in a previous advertisement area according to a result of a past bidding, information about a click rate indicating a number of clicks of the previous advertisement with respect to a number of impression of the previous advertisement, a number of participations of the advertiser in an auction during a preset period, a number of winning by the advertiser, a winning price, and a budget of the advertiser during the preset period.

7. The server of claim 1, wherein the user information included in the bidding request comprises information about at least one of gender of the user, a date of birth of the user, a location of the user, a time of access of the user, a terminal device used by the user, whether the user is under general data protection regulation (GDPR), whether the user clicks the advertisement, a search keyword of the user, information on an on-line publisher providing the advertisement area, information on the advertisement area, or a preference of the user with respect to the advertisement area.

8. The server of claim 1, wherein the auction-related data of the advertiser comprises information about at least one of a number of remaining auctions during a bidding period of the advertiser and an amount of a remaining budget out of an entire budget of the advertiser.

9. A method of controlling a server, the method comprising:
receiving a bidding request for an advertisement area from an external server that manages posting, on a network, an advertisement for the advertisement area;
obtaining response probability data of a user with respect to the advertisement area based on user information included in the bidding request, the response probability data indicating a probability of the user responding to the advertisement posted in the advertisement area;
obtaining a first winning probability distribution by inputting auction-related data of an advertiser and the response probability data of the user to a first neural network model and obtaining a second winning probability distribution by inputting noise data to a second neural network model;
identifying a bidding price based on the first and second winning probability distributions, upon which a winning advertiser whose advertisement is to be posted in the advertisement area is determined; and
transmitting the identified bidding price to the external server,
wherein the first neural network model is trained to predict the first winning probability distribution for a bidding price based on advertisement history data of the advertiser, and
wherein the second neural network model is trained to output the second winning probability distribution, an approximation degree between the first winning probability distribution output from the first neural network model and the second winning probability distribution exceeding a threshold value.

10. The method of claim 9, wherein the second neural network model is a generator model in which a probability value output from a discriminator model exceeds the threshold value, and
wherein the discriminator model is trained to output a probability value for the approximation degree between the first winning probability distribution output from the first neural network model and the second winning probability distribution output from the second neural network model.

11. The method of claim 9, wherein the identifying comprises identifying a bidding price that has a highest winning probability among winning probabilities for respective bidding prices based on the first and second winning probability distributions obtained from the first and second neural network models.

12. The method of claim 9, further comprising:
based on receiving information about a budget consumption ratio of the advertiser, storing the information about the budget consumption ratio in a memory of the server,
wherein the identifying comprises identifying the bidding price based on the first and second winning probability distributions and the stored budget consumption ratio.

13. The method of claim 9, further comprising:
based on receiving information about a maximum payment amount of the advertiser, storing the information about the maximum payment amount per auction in a memory of the server,
wherein the identifying comprises identifying a bidding price having a highest winning probability within a range of the maximum payment amount among winning probabilities for respective bidding prices based on the first and second winning probability distributions obtained from the first and second neural network models.

14. The method of claim 9, wherein the advertisement history data comprises, based on the advertiser posting a previous advertisement in a previous advertisement area according to a result of a past bidding, information about a click rate indicating a number of clicks of the previous advertisement with respect to a number of impression of the previous advertisement, a number of participations of the advertiser in an auction during a preset period, a number of winning by the advertiser, a winning price, and a budget of the advertiser during the preset period.

15. The method of claim 9, wherein the user information included in the bidding request comprises information about at least one of gender of the user, a date of birth of the user, a location of the user, a time of access of the user, a terminal device used by the user, whether the user is under general data protection regulation (GDPR), whether the user clicks the advertisement, a search keyword of the user, information on an on-line publisher providing the advertisement area, information on the advertisement area, or a preference of the user with respect to the advertisement area.
